(19) United States
(12) Patent Application Publication
(10) Pub. No.: US 2005/0060193 A1
(43) Pub. Date: Mar. 17, 2005

(54) System and method for evidence-based modeling of clinical operations

(76) Inventors: Brian J. Lancaster, Merriam, KS (US); Spencer Roy Stout, Liberty, MO (US); Jay E. Linney, Kansas City, MO (US)

Correspondence Address: SHOOK, HARDY & BACON L.L.P., 2555 GRAND BOULEVARD, KANSAS CITY, MO, 64108-2613, US

(21) Appl. No.: 10/720,086

(22) Filed: Nov. 25, 2003

Related U.S. Application Data
(60) Provisional application No. 60/498,283, filed on Aug. 28, 2003.
(60) Provisional application No. 60/508,273, filed on Oct. 6, 2003.

(51) Int. Cl. G06F 17/60

(52) U.S. Cl. 705/2

(57) ABSTRACT

A system and related techniques relates to the collection and analysis of clinical medical, pharmaceutical and other data by comparison against standardized or proprietary medical guidelines or standards. For instance according to the invention a hospital or set of hospital or other clinical, research or other facilities may transmit data on patient outcomes, pharmaceutical prescriptions, surgical procedures recommended and employed and other clinical, financial or other operational details to a data warehouse. That data may then be extracted for comparison and modeling against a knowledge base containing recommended medical and other practices. That dynamic modeling may for instance include projective or evidence-based forecasting of patient outcomes and other results which may ensue from changing medical and other operational policies, for instance to conform drug, surgery or other policies to best practices guidelines. A medical director, office or other may therefore model and simulate the best changes to their hospital or other operation, constrained on either side by both empirical data and standardized medical guidelines to maintain a desired quality of operation.

### CROSS-REFERENCE TO RELATED APPLICATIONS

The subject matter of this application is related to the subject matter of U.S. Provisional Patent Application Ser. No. 60/498,283 filed Aug. 28, 2003 entitled “System and Method for Multidimensional Extension of Database Information”, to the subject matter of U.S. patent application Ser. No. 10/______ filed Sep. 22, 2003 entitled “System and Method for Multidimensional Extension of Database Information”, and to the subject matter of U. S. Provisional Patent Application Ser. No. 60/508,273 filed Oct. 6, 2003 entitled “System and Method for Management Interface for Clinical Environments”, each of which applications is assigned or under obligation of assignment to the same entity as this application, and each of which is incorporated in this application by reference.

### STATEMENT REGARDING FEDERALLY SPONSORED RESEARCH OR DEVELOPMENT

Not applicable.

### FIELD OF THE INVENTION

The invention relates to the field of management information systems, and more particularly to a platform for managing medical operations by dynamically modeling clinical policies using best practices guidelines.

### BACKGROUND OF THE INVENTION

Management information systems have been commercially deployed which permit a medical director, chief information office or other managers to collect, track and analyze a variety of aspects of hospital and other clinical sites. For instance, packages exist which may track and capture diagnostic, outcomes, pharmaceutical and other clinically-related data from one or more hospitals, clinics or other facilities. A manager may then use data mining tools such as structured query language (SQL) engines to run reports off of the data store for their clinical operation. Managers and others may for instance run queries to see whether the number of patient bed-days has increased in the past year, or the cardiology department shows a positive profit trend. While these types of internal analytics may be helpful, there are limitations to the flexibility and sophistication of current clinical management systems in the medical arena. For one, while many packages permit the analysis of clinical operations by way of reports rolled up from raw clinical data, they may not permit a manager to model or simulate what would happen if various operational policies were changed. For instance, a data package might permit a chief cardiologist or others to determine how many shunt catheterizations were performed in the unit last year, but not allow that manager to forecast or project the effect on patient outcomes if more balloon angioplasties were substituted or combined with that surgical procedure.

As a further drawback, even if a medical information system permits a manager or other user to predict or simulate the resulting patient, financial or other outcomes from changes in various drug, surgical or other clinical policies, platforms today may do so today based only on the internally generated clinical data sets created by that operator. Whatever simulations may be performed may, in other words, be based upon empirical data but be unconstrained on the other side by other objective guidelines. Other problems and limitations exist.

### SUMMARY OF THE INVENTION

The invention overcoming these and other problems in the art relates in one regard to a system and method for evidence-based modeling of clinical operations, in which a user may run predictive analytics off of clinical data stores, based on one side by empirical data captured from clinical sites but constrained on the other side by objective medical or clinical guidelines. In embodiments, an inference engine may access a data warehouse storing sets of clinical data related to hospital, clinic, research, government or other sites and also access a knowledge base of standardized or baseline clinical guidelines. The inference engine may compare the results on the ground from those clinical facilities to that objective set of guidelines or criteria, and model or project the estimated changes in operational outcomes if internal policies and procedures were to be changed, for instance to conform drug, surgery or other policies to recommended practice guidelines. The user may also re-model the clinical outcomes over time to determine how various factors contribute to changing clinical results and inter-relate to each other under shifting clinical scenarios and policies.

### BRIEF DESCRIPTION OF THE DRAWINGS

FIG. 1 illustrates an overall architecture in which an evidence-based modeling platform according to an embodiment of the invention may operate.

FIG. 2 illustrates a dynamic analytical module with associated displays according to an embodiment of the invention.

FIG. 3 illustrates a dynamic analytical module including a projective analysis of clinical operations, according to an embodiment of the invention.

FIG. 4 illustrates a dynamic analytical module including an empirical breakdown according to an embodiment of the invention.

FIG. 5 illustrates a dynamic analytical module including an updated projective analysis, according to an embodiment of the invention.

FIG. 6 illustrates a flowchart of overall analytic operation, according to an embodiment of the invention.

### DETAILED DESCRIPTION OF EMBODIMENTS

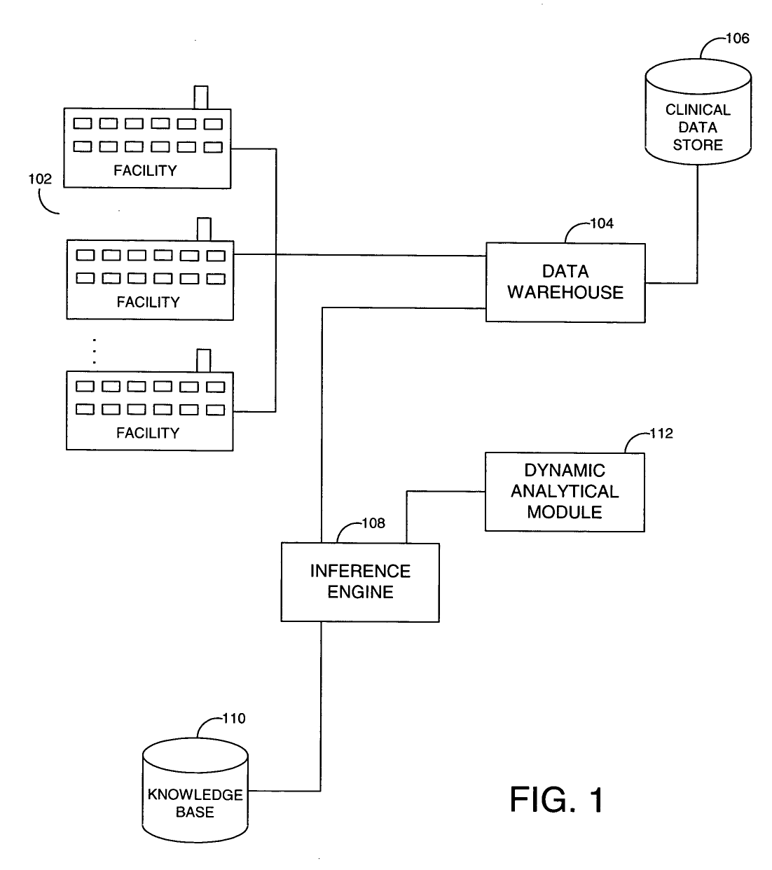

FIG. 1 illustrates an architecture in which a system and method for evidence-based modeling of clinical operations may operate, according to an embodiment of the invention. As illustrated in that figure, one or more clinical facility in a set of clinical facilities 102 may collect, condition and transmit captures of clinically-related data and communicate that information to a data warehouse 104 to store in a clinical data store 106. The set of clinical facilities 102 may include, for instance, hospitals, clinics, research sites, corporate facilities, government or military sites or other facilities which conduct medically-related operations. The clinically-related data may include, for example, a variety of medical, financial, operational, administrative and other information, including, for instance sets of patient identification data, diagnosis data, patient morbidity, mortality and recovery rates, drug prescription and other drug delivery and management information, hospital or other occupancy data, revenue streams by department or facility, supply or capital cost information, medical staff information, scheduling information, or other types of information related to clinical operations.

The clinically-related data may be communicated, for instance via a local area network (LAN), virtual private network (VPN), the Internet or other networks or connections to a data warehouse 104 for storage and manipulation on a clinical data store 106. The data warehouse 104 may include, for instance, a query engine such as a SQL engine or other resources to facilitate the maintenance, interrogation and transmission of the clinically-related data and other data stored on clinical data store 106. Clinical data store 106 may be or include a large-scale or other database hosting facility, such as a site including or interfacing to, for example, relational databases such as the Oracle™ relational database sold commercially by Oracle Corp. or others. Other storage or query formats, platforms or resources such as OLAP (On Line Analytical Processing), SQL, storage area networks (SANs), redundant arrays of independent disks (RAID) or others may also be used, incorporated or accessed by clinical data store 106, which may be supported by server or other resources.

The data warehouse 104 may likewise communicate with an inference engine 108 configured to execute or access a dynamic analytical module 112 which analyzes or models the content of clinically-related data. Inference engine 108 may for example execute on a local or remote workstation communicating via a communications link such as the Internet or other network or connection with data warehouse 104. Inference engine 108 may similarly communicate with a knowledge base 110 containing medical, clinical or other operational or other guidelines. The guidelines and other normative information contained in knowledge base 110 may for instance include recommended or best practices for different categories of diseases, patients or treatments as well as other clinical baseline or objective data. In embodiments the knowledge base 110 may include or access clinical guidelines published or released by Zynx Health Inc. Other sources of objective or evidence or research-based clinical guidelines may be assessed or incorporated, such as for example data published or provided by the Joint Commission on Accreditation of Healthcare Organizations. Other public or private sources or combinations of sources of clinically-related criteria or guidelines may be used.

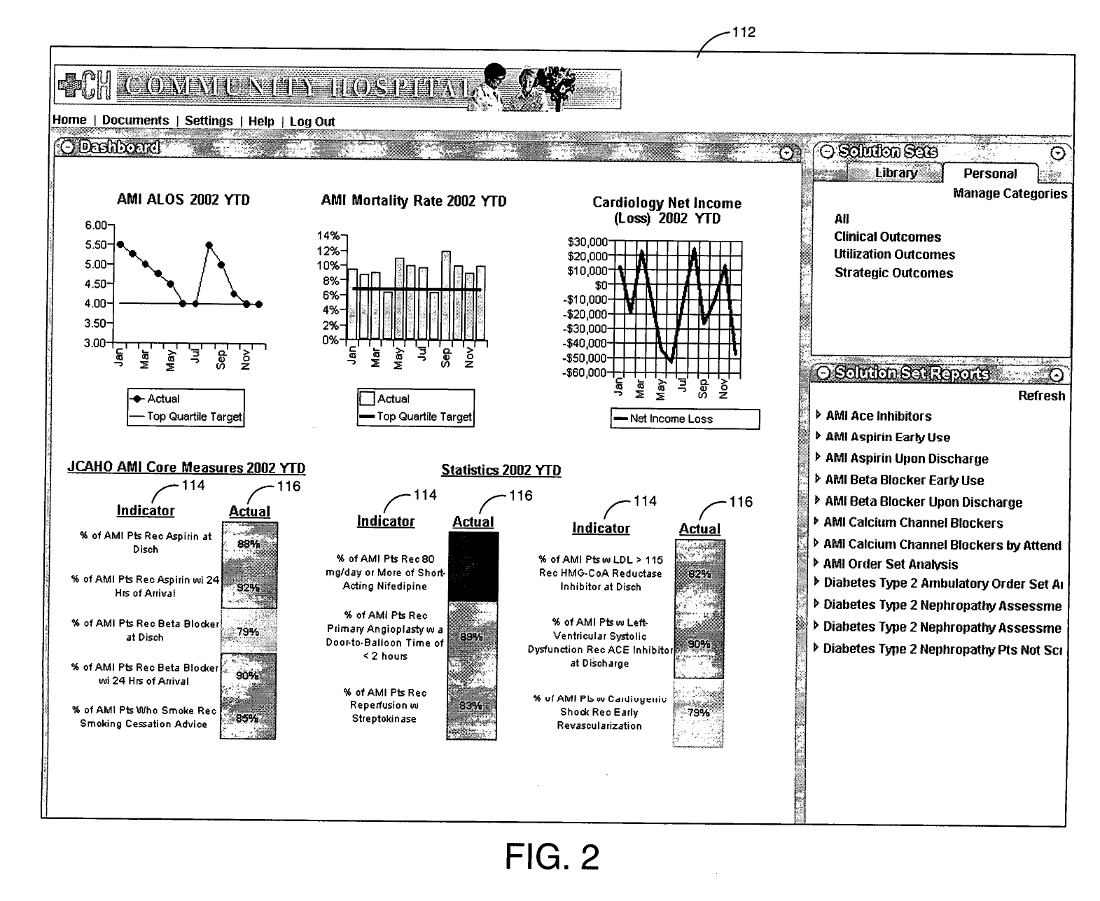

As illustrated in FIG. 2, a medical director, unit director, chief information officer or other user may operate the dynamic analytical module 112 to analyze and predict the possible operational effects of altering clinical policy in a facility or organization. The dynamic analytical module 112 may permit users to analyze data in at least three ways or modes, including the use of key performance indicators 114, for instance in a dashboard-style user interface, the use of standardized or preselected solution set reports and the use of dynamic or user-created reports. As illustrated, when users sign on or otherwise access the dynamic analytical module 112, for instance via a home page, they may be presented with selectable actions or portlets. The first illustrative portlet shown in FIG. 2 is the user's dashboard, which displays the key performance indicators 114 that the user has selected to monitor. The key performance indicators 114 may provide an overview of significant financial, operational and clinical metrics required to effectively run a hospital or other facility. By providing up to date information of past performance, current trends and forecasts, users may be directed to significant metrics to focus attention on. The dashboard or other interface can be customized to selectively display the most significant key performance indicators 114 for individual users, as well as to configure the display of that data and associated thresholds above or below which an alert may be triggered. Other data presentation options and metrics may be displayed, including combined graphical outputs such as those described in the aforementioned U.S. Provisional Patent Application Ser. No. 60/508,273.

As illustrated another portlet in the dynamic analytical module 112 may present the user with the different categories of solution sets. Selecting one of those metrics may flex the listed solution set reports to display associated preconfigured reports. An accessible solution set of this type may be or include a collection of predefined report templates for a particular process in common healthcare settings. Illustratively those solution set offerings may include clinical outcomes, strategic outcomes and utilization outcomes. Other templates or metrics may be used. In embodiments of the invention in another regard, the data stored in clinical data store 106 and accessible via data warehouse 104 or otherwise may be or include data sets which have been processed to generate multidimensional extensions to the raw source data as described in the aforementioned U.S. Provisional Patent Application Ser. No. 60/498,283 and U.S. patent application Ser. No. 10/______, thereby extending the power and flexibility of queries and reports.

As further illustrated in FIG. 2, when a solution set is selected and displayed, a user may review the resulting key performance indicators 114 for the desired operational unit and determine that the mortality rate for acute myocardial infarction (AMI) patients in 2002 was higher than the top quartile target, the cardiology service line is currently losing money and that there is a significant rate of AMI patients receiving a pharmaceutical having a known risk factor, namely 80 mg/day or more of short-acting nifedipine. This set of data may alert the user to take more closely examine the clinically-related data 116.

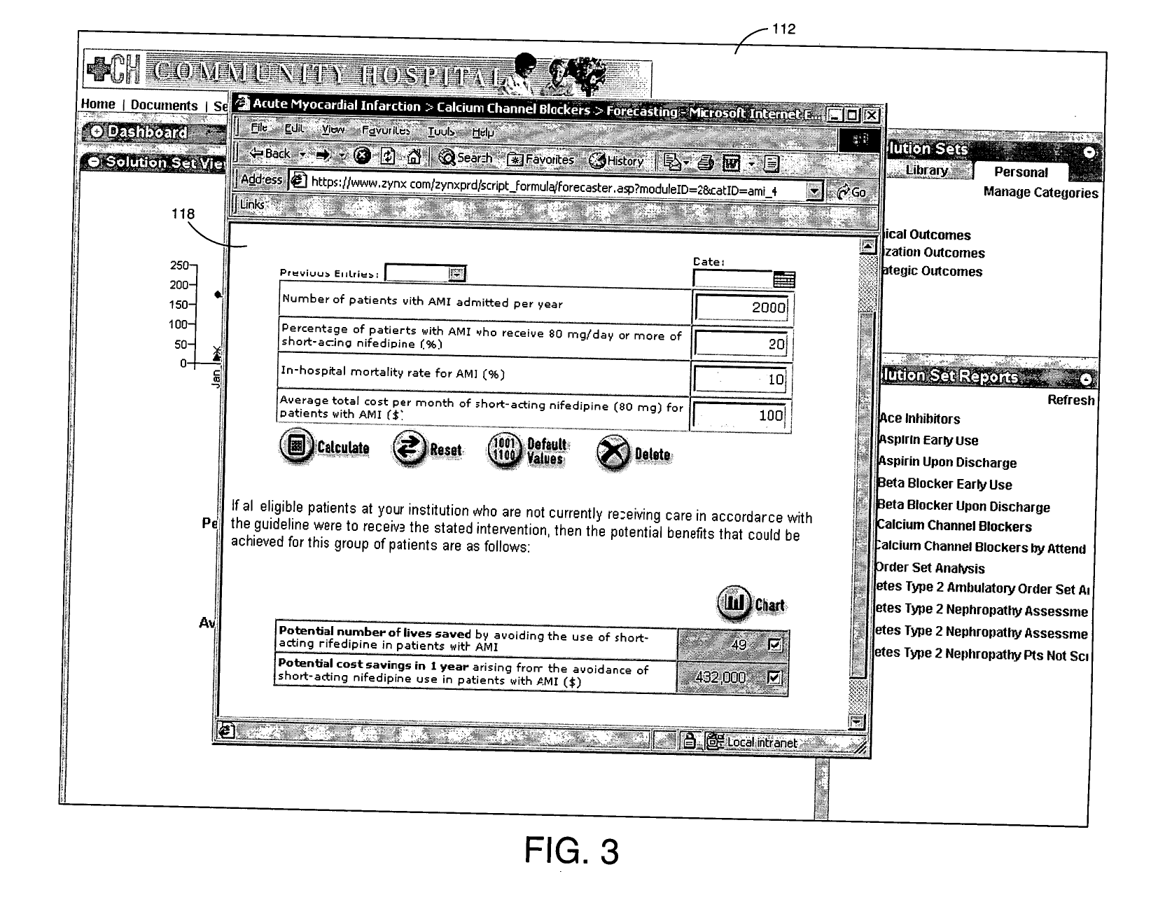

The user may then review the solution set entitled “AMI—Calcium Channel Blockers”, for instance by activating the embedded link. As illustrated in FIG. 3, that action may call up a dialog box which presents the number of AMI patients seen in 2002, the percent of those patients that received 80 mg/day or more of short-acting nifedipine, the in-hospital mortality rate for AMI patients and the average total cost per month of short-acting nifedipine (80 mg) for AMI patients. The user interface may indicate by way of an alert, blinking highlight or other presentation that there is an exception with the rate of patients receiving nifedipine. In order to understand what the normative results should be, users may for instance activate an “Evidence” link or otherwise access clinical content from knowledge base 110 or other sources.

As further illustrated in FIG. 3, comparing the clinically-related data 116 in question against the knowledge base 110 may generate a projective analysis 118 on dynamic analytical module 112. The projective analysis 118 may present evidence pointing out that existing mortality data on short-acting nifedipine are anomalous, documentation of long-term safety is lacking and that emerging research data demonstrates a possible link between nifedipine and an excessive number of cardiovascular events. Based on this evidence, the established guideline is that use of the pharmaceutical in question should be avoided in patients with AMI.

The user may perceive that as a matter of clinical policy their organization's AMI patients should not be receiving short-acting nifedipine, while AMI patients actually received short-acting nifedipine 20% of the time in the illustrated year of 2002. The projective analysis 118 may quantify the opportunity for improvement if the evidence-based guidelines were followed. This may be done for instance by activating an embedded “Forecast” link, to display a projective analysis 118. The projective analysis 118 as shown demonstrates that if the pharmaceutical guideline were followed, in the user's clinical facility there is the potential to save approximately 49 lives as well as the costs of approximately $432,000 by adopting the policy or procedure of avoiding the use of short-acting nifedipine in AMI patients.

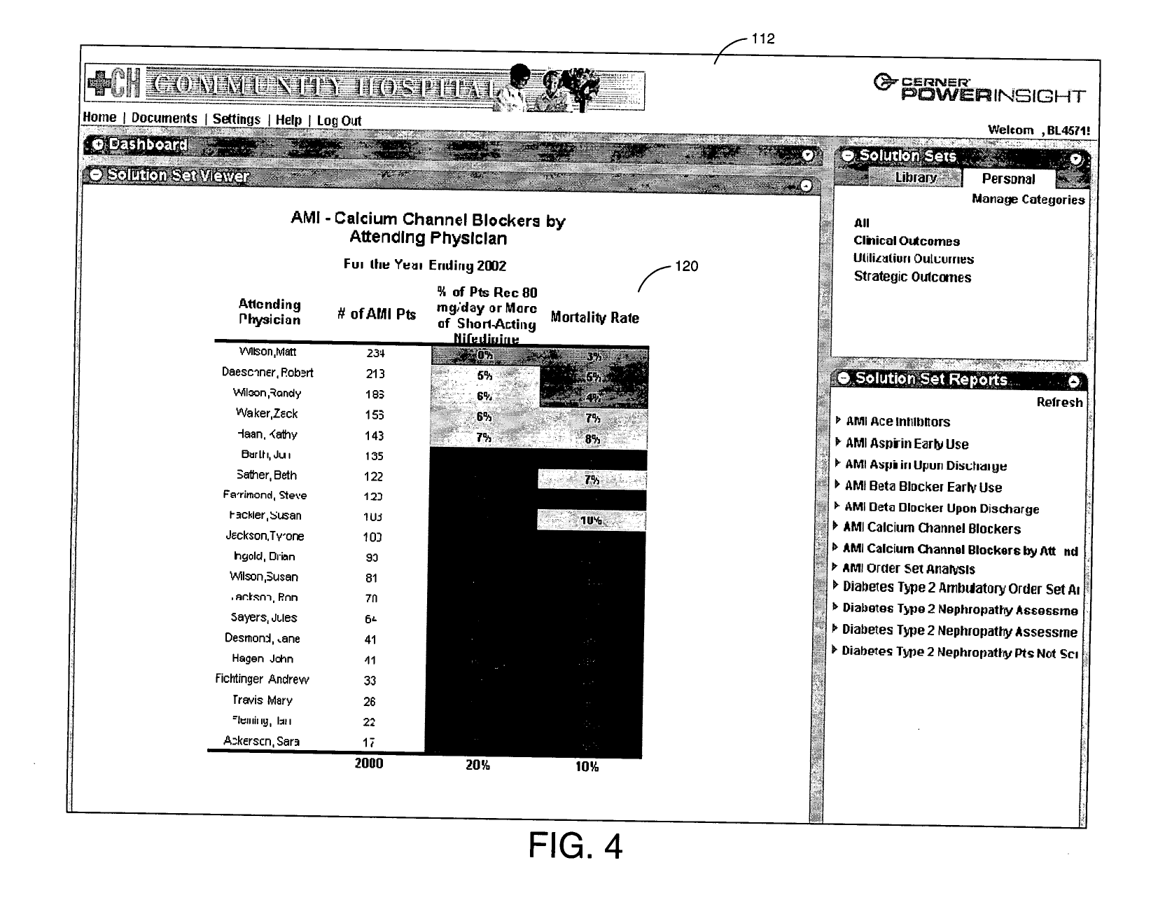

After establishing a quantified opportunity for improvement, the user may further analyze the clinical environment by generating additional reports, for instance using defined solution sets or additional custom queries. For example, as illustrated in FIG. 4 the user can review the rate of AMI patients receiving 80 mg/day or more of short-acting nifedipine and mortality rate by further empirical breakdown 120, which in this case is illustrated by prescription rates by attending physician to see if the rate is the same for all physicians or if there are outliers in the care group. It can be seen that there are a few attending physicians performing better than the others in conforming to recommended practices, but for the larger part the medical staff population is in the 20-40% range for AMI patients receiving 80 mg/day or more of short-acting nifedipine. Once this trend is identified, an order set, a clinical alert or other policy or management update can be authored. That alert or other update or bulletin may be communicated to clinical data store 106 or other locations. This may permit the clinical facility to systematically reduce the rate at which care providers prescribe 80 mg/day or more of short-acting nifedipine for AMI patients. In further embodiments of the invention, individual doctors or others may be permitted to override given alerts, limits or criteria according to clinical judgment or exceptional circumstances, for instance due to drug contraindications. It may be noted that regulatory or other requirements may dictate the reporting of such overrides on alerts to governing medical bodies or others. In implementations the dynamic analytical module 112 or other resources may catalog overrides or otherwise assist in the necessary record keeping for that function.

According to the invention in another regard, the dynamic analytical module 112 may help to identify an overall trend in the clinically-related data 116 at a high level from one or more key performance indicators 114, and drill further into the clinically-related data 116 to permit a user to assess further levels of detail, for instance to assess data at the level of individual patients or groups of patients or others.

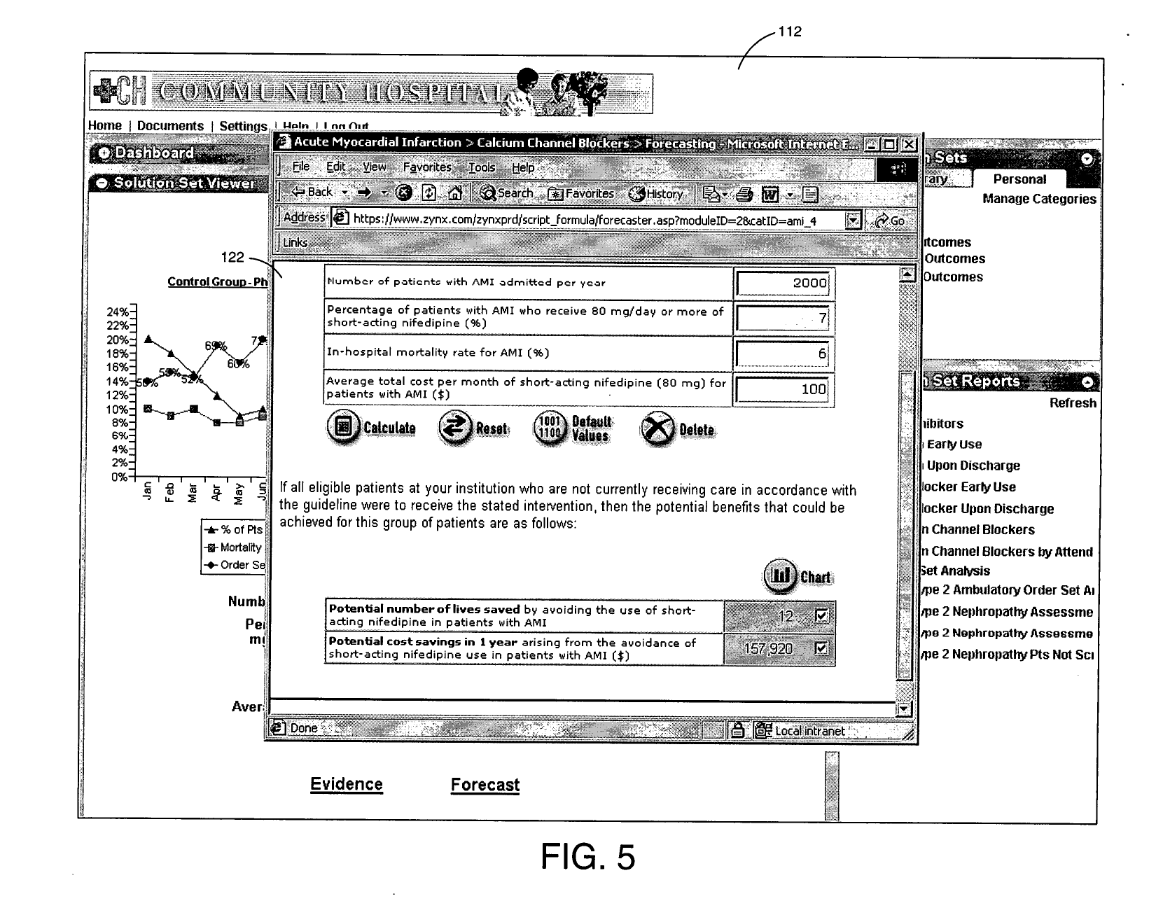

As illustrated in FIG. 5, once a management update such as an order set or alert is implemented, further monitoring and analysis can be done to continue to improve outcomes and other desired targets. Alerts, policies and outcome improvements can therefore be iterated and refined. The illustrative updated projective analysis 122 in FIG. 5 analyzes the usage of the order set and forecasts the percentage of AMI patients receiving 80 mg/day or more of short-acting nifedipine at the end of 2003. This analysis also compares a control group of the physicians using the order set to a non-control group of physicians not adhering to the order set. From the comparisons it can be seen that there appears to be a decrease in the AMI patients receiving 80 mg/day or more of short-acting nifedipine for the control group and a consistent rate with the non-control group. The measurement provided by the updated projective analysis 122 shows that if the revised pharmaceutical guideline were followed, there is the potential of saving the lives of 12 patients under care and achieving a savings of $157,920 from the avoidance of short-acting nifedipine. This is a projected 37 patients and $274,080 less than in 2002 before the implementation of the revised order set.

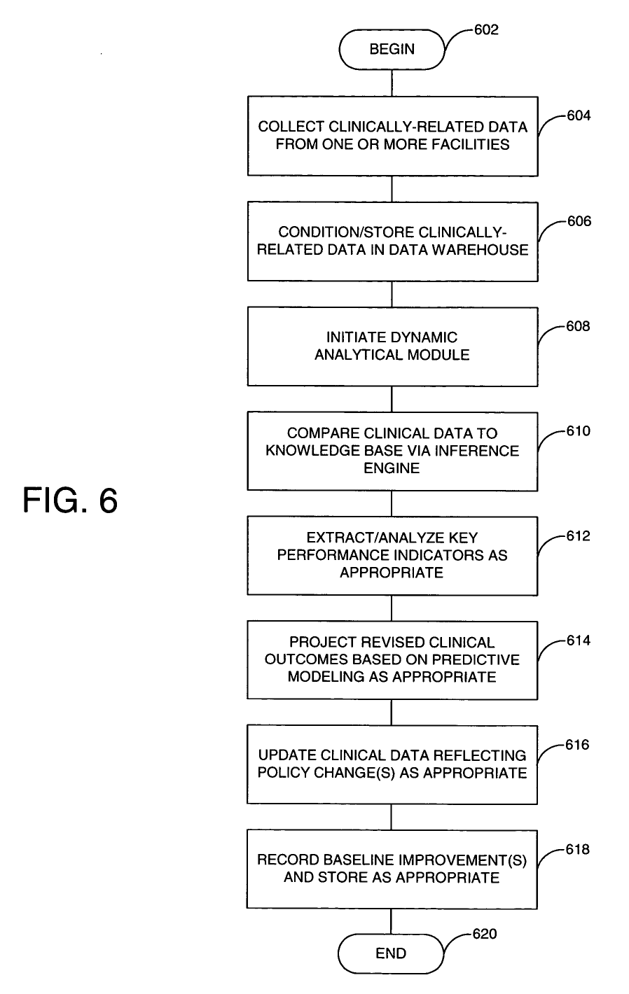

Overall analytic processing according to an embodiment of the invention is illustrated in FIG. 6. In step 602, processing may begin. In step 604, clinically-related data 116 may be collected from one or more facility in the set of clinical facilities 102. For instance the clinically-related data 116 may relate to or include information regarding patient morbidity, patient mortality, disease classifications, physician information, cost information, procedure information, prescribed drug information, and other clinically-related information. In step 606, the clinically-related data 116 may be conditioned as appropriate and stored in a database or archival facility such as clinical data store 106 associated with data warehouse 104, or in other local or remote, centralized or distributed resources.

In step 608, clinical modeling and forecasting may be initiated, for instance by way of dynamic analytical module 112 or other resources. In step 610, the clinically-related data 116 may be compared against data in the knowledge base 110 in the inference engine 108, for instance to detect whether clinically driven or mandated guidelines, thresholds or limits have been reached or not for given recovery rates, drug delivery, patient readmittance or other variables or factors. In step 612, an operator such as a medical director, chief information officer or other user may manipulate the dynamic analytical module 112 to extract key performance indicators 114 such as drug delivery or prescription rates for identified pharmaceuticals, the frequency or elapsed time with which a surgical or other procedure is employed, or other clinical, diagnostic, financial or other data or variables.

In step 614, an operator may model the clinically-related data 116 to generate a predictive analysis 118 which projects revised clinical outcomes as a function of changed drug delivery, surgical, patient discharge or other procedures. In step 616, the clinically-related data 116 may be updated after a change in policy or procedures for those and other types of procedures, for instance to determine whether patient outcomes, costs or other factors have improved or declined. In step 618, the baseline improvements or other changes may be stored to clinical data store 106 or to other data stores or resources. In step 620, processing may terminate, repeat or return to a prior processing point.

The foregoing description of the invention is illustrative, and modifications in configuration and implementation will occur to persons skilled in the art. For instance, while the invention has generally been described in terms of a single inference engine 110 which communicates with a single knowledge base 110 to perform comparative analytics, in embodiments more than one distributed logic engines or modeling modules may access the clinical data and knowledge base independently or together. Likewise, in implementations more than one knowledge base 110, data warehouse 104 or other comparable data resources may supply raw clinical data and baseline clinical guidelines and other information for use in evidence-based analysis and forecasting of clinical operations.

Similarly, while the invention has in embodiments been described as extracting key performance indicators 114 to drive projective analytics, other variables or groups of variables may be selected or employed. Other hardware, software or other resources described as singular may in embodiments be distributed, and similarly in embodiments resources described as distributed may be combined. The scope of the invention is accordingly intended to be limited only by the following claims.

1. A system for analyzing clinically related data, comprising:
a first interface to a clinical data store storing clinically related data;
a second interface to a knowledge base; and
an inference engine, the inference engine communicating with the clinical data store via the first interface and with the knowledge base via the second interface, the inference engine configured to selectively perform comparative analysis of the clinically related data against the knowledge base.

2. A system according to claim 1, wherein the clinical data store comprises a data warehouse.

3. A system according to claim 2, wherein the data warehouse stores clinically related data from at least one clinical facility.

4. A system according to claim 3, wherein the at least one clinical facility comprises at least one of a hospital site and a research site.

5. A system according to claim 1, wherein the comparative analysis comprises an analysis of at least one key performance indicator.

6. A system according to claim 1, wherein the knowledge base comprises a set of clinical guidelines.

7. A system according to claim 6, wherein the clinical guidelines comprise best practices data.

8. A system according to claim 7, wherein the best practices data comprises pharmaceutical information, medical procedure information and historical outcomes information.

9. A system according to claim 1, wherein the inference engine generates projected outcomes information based on the clinically related data and the knowledge base.

10. A system according to claim 9, wherein the projected outcomes information comprises at least one of estimated patient mortality information, estimated patient morbidity information and estimated clinical cost information.

11. A system according to claim 1, wherein the inference engine stores the comparative analysis to storage.

12. A method of analyzing clinically related data, comprising:
accessing clinically related data;
accessing a knowledge base; and
selectively performing a comparative analysis of the clinically related data against the knowledge base.

13. A method according to claim 12, wherein the step of accessing clinically related data comprises accessing a data warehouse.

14. A method according to claim 13, wherein the data warehouse stores clinically related data from at least one clinical facility.

15. A method according to claim 14, wherein the at least one clinical facility comprises at least one of a hospital site and a research site.

16. A method according to claim 12, wherein the step of selectively performing a comparative analysis comprises performing an analysis of at least one key performance indicator.

17. A method according to claim 12, wherein the knowledge base comprises a set of clinical guidelines.

18. A method according to claim 17, wherein the clinical guidelines comprise best practices data.

19. A method according to claim 18, wherein the best practices data comprises pharmaceutical information, medical procedure information and historical outcomes information.

20. A method according to claim 12, wherein the step of performing a comparative analysis comprises a step of generating projected outcomes information based on the clinically related data and the knowledge base.

21. A method according to claim 20, wherein the projected outcomes information comprises at least one of estimated patient mortality information, estimated patient morbidity information and estimated clinical cost information.

22. A method according to claim 12, further comprising a step of storing the comparative analysis to storage.

23. An analytic clinical report, the report being generated according to a method of:
accessing clinically related data;
accessing a knowledge base; and
selectively performing a comparative analysis of the clinically related data against the knowledge base.

24. A report according to claim 23, wherein the step of accessing clinically related data comprises accessing a data warehouse.

25. A report according to claim 23, wherein the step of selectively performing a comparative analysis comprises performing an analysis of at least one key performance indicator.

26. A report according to claim 23, wherein the knowledge base comprises a set of clinical guidelines.

27. A report according to claim 23, wherein the step of selectively performing a comparative analysis comprises a step of generating projected outcomes information based on the clinically related data and the knowledge base.

28. A report according to claim 27, wherein the projected outcomes information comprises at least one of estimated patient mortality information, estimated patient morbidity information and estimated clinical cost information.

29. A system for analyzing clinically related data, comprising:
communications interface means, the communications interface means comprising a first interface to clinical data storage means for storing clinically related data and a second interface to knowledge base means for storing clinical guidelines; and
inference engine means, the inference engine means communicating with the clinical data store and with the knowledge base via the communications interface means, the inference engine means configured to selectively perform comparative analysis of the clinically related data against the clinical guidelines.

30. A system according to claim 29, wherein the clinical data storage means comprises a data warehouse.

31. A system according to claim 29, wherein the comparative analysis comprises an analysis of at least one key performance indicator.

32. A system according to claim 29, wherein the inference engine means generates projected outcomes information based on the clinically related data and the clinical guidelines.

33. A system according to claim 32, wherein the projected outcomes information comprises at least one of estimated patient mortality information, estimated patient morbidity information and estimated clinical cost information.

34. A system according to claim 29, wherein the inference engine means stores the comparative analysis to storage.
